(19) United States
(12) Patent Application Publication
(10) Pub. No.: US 2010/0297501 A1
(43) Pub. Date: Nov. 25, 2010

(54) NEGATIVE ELECTRODE FOR LITHIUM SECONDARY BATTERY, AND LITHIUM SECONDARY BATTERY USING THE SAME

(75) Inventors: Eiji SEKI, Hitachi (JP); Kazushige Kohno, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: HITACHI, LTD.

(21) Appl. No.: 12/712,585

(22) Filed: Feb. 25, 2010

(30) Foreign Application Priority Data
May 22, 2009 (JP) 2009-123665

(51) Int. Cl. H01M 4/58

(52) U.S. Cl. 429/231.8

(57) ABSTRACT

The objects of the present invention are to provide a negative electrode for lithium secondary battery which can simultaneously satisfy high energy density and good charge/discharge cyclic characteristics, and to provide a lithium secondary battery which uses the negative electrode.
The negative electrode of the present invention for lithium secondary battery contains natural graphite as an active material and contains a copolymer of polyvinylidene fluoride and hexafluoropropylene as a binder, wherein the graphite has an I_{[110]a}/I_{[004]c} ratio of 0.13 or more (wherein I_{[110]c} is X-ray diffraction peak intensity of [110]c plane and I_{[004]c} is that of [004]c plane, determined by X-ray diffraction 2θ/θ analysis of graphite relative to a principal plane of the electrode).

### FIELD OF THE INVENTION

The present invention relates to a lithium secondary battery, in particular negative electrode for lithium secondary battery useful for improving energy density and cyclic characteristics, and lithium secondary battery using the same.

### BACKGROUND OF THE INVENTION

Patent Documents 1 to 10 disclose electrodes and lithium secondary batteries which use a copolymer of polyvinylidene fluoride and hexafluoropropylene as a binder.
Patent document 1: JP-A-2002-313345
Patent document 2: JP-A-2002-216769
Patent document 3: JP-A-2002-030263
Patent document 4: JP-A-2001-307735
Patent document 5: JP-A-2001-076758
Patent document 6: JP-A-2000-133270
Patent document 7: JP-A-11-339809
Patent document 8: JP-A-11-003710
Patent document 9: JP-A-08-130016
Patent document 10: JP-A-06-111823

### SUMMARY OF THE INVENTION

A lithium secondary battery has characteristics of being lighter and having higher capacity and output than a nickel hydride battery or lead-acid storage battery. In order to utilize these characteristics, a lithium secondary battery has been demanded to have higher energy density and more excellent cyclic characteristics as a power source for portable electronic devices or the like and, more recently, as a power source for power storage.

Materials for the negative electrode of lithium secondary battery generally include graphitic materials (e.g., natural graphite and synthetic graphite produced from coke, density: about 2.2 g/cm³) and amorphous carbonaceous materials (e.g., heat-treated oil- or coal-derived tar and coal-derived pitch, density: about 1.5 g/cm³). Of these, natural graphite as one of graphitic materials has been considered to be suitable for improving energy density of lithium secondary batteries, because it has a potential for increasing electrode density, coming from its high crystallinity, high discharge capacity close to the theoretical level and high intrinsic density.

However, its high crystallinity is accompanied by large volumetric expansion/contraction resulting from charge/discharge cycles involving insertion/elimination of the lithium ion, which tends to destroy the electrode to deteriorate cyclic characteristics of lithium secondary battery with the electrode. Therefore, binders resistant to volumetric expansion/contraction of lithium secondary battery have been studied and developed to solve the above problems.

However, the conventional negative electrode for lithium secondary battery, which uses natural graphite as an active material, shows initial capacity fairly lower than the theoretical level, even in the presence of copolymer of polyvinylidene fluoride and hexafluoropropylene as a binder, and cyclic characteristic improvements lower than expected. In other words, there are problems to be solved for realization of lithium secondary battery having high energy density, excellent cyclic characteristics and long serviceability.

Therefore, it is an object of the present invention to provide a negative electrode which can simultaneously satisfy high energy density and good charge/discharge cyclic characteristics in order to solve the above problems. It is another object to provide the lithium secondary battery which uses the negative electrode.

The present invention provides a negative electrode for lithium secondary battery,

wherein the negative electrode contains natural graphite as an active material and contains a copolymer of polyvinylidene fluoride and hexafluoropropylene as a binder, and

the graphite has an I_{[110]c}/I_{[004]c} ratio of 0.13 or more (wherein I_{[110]c}, is X-ray diffraction peak intensity of [110]c plane and I_{[004]c} is x-ray diffraction peak intensity of [004]c plane, determined by X-ray diffraction 2θ/θ analysis of graphite relative to a principal plane of the electrode).

The present invention can make the following modifications or variations of the negative electrode and lithium secondary battery in order to achieve the object:

(1) The natural graphite has an aspect ratio La/Lc of from 0.9 to 1.1 (wherein La is an average size in a-axis direction and Lc is an average size in c-axis direction in a graphite crystallite).

(2) The binder has a molecular weight of from 800,000 to 1,200,000.

(3) The lithium secondary battery having a positive electrode and negative electrode facing each other via a separator and containing an electrolytic solution, wherein the positive electrode contains a positive electrode-active material and the negative electrode contains a negative electrode-active material, wherein the negative electrode is that of the present invention.

(4) The lithium secondary battery having a positive electrode and negative electrode facing each other via a solid electrolyte and containing an electrolytic solution, wherein the positive electrode contains a positive electrode-active material and the negative electrode contains a negative electrode-active material, wherein the negative electrode is that of the present invention.

Other objects, features and advantages of the invention will become apparent from the following description of the embodiments of the invention taken in conjunction with the accompanying drawings.

### ADVANTAGES OF THE INVENTION

The present invention provides a negative electrode which can give a lithium secondary battery which can simultaneously satisfy high energy density and good charge/discharge cyclic characteristics to a higher extent than the conventional techniques, and also provides the lithium secondary battery which uses the negative electrode.

### BRIEF DESCRIPTION OF THE DRAWINGS

FIG. 1 shows one example of the XRD analysis results (XRD chart) of the negative electrode of the present invention for lithium secondary battery.

FIG. 2 shows partly magnified XRD charts of the negative electrode of the present invention and conventional negative electrode for lithium secondary battery, wherein (a) diffraction peaks of the [004]c plane and (b) diffraction peaks of the [110]c plane.

FIG. 3 shows a general chemical composition formula of copolymer of polyvinylidene fluoride and hexafluoropropylene.

FIG. 4 shows one example of partial longitudinal sectional view of the lithium secondary battery (cylindrical battery).

FIG. 5 is a view schematically showing disassembled test cell used for the analysis.

### DETAILED DESCRIPTION OF THE INVENTION

The inventors of the present invention have found, after having extensively studied the causes for lower initial capacity of the conventional lithium secondary battery with natural graphite as an active negative electrode material than the theoretical level and for insufficient cyclic characteristics, that these causes are related to crystalline orientation of the natural graphite particles in the negative electrode, achieving the present invention based on the extensive studies on the causes. The embodiments of the present invention are described by referring to the attached drawings. It should be understood that the present invention is not limited to the embodiments, and that they can be combined with each other or modified within the scope of the present invention.

### (Structure of Negative Electrode for Lithium Secondary Battery)

The negative electrode of the present invention for lithium secondary battery contains natural graphite as an active material and a copolymer of polyvinylidene fluoride and hexafluoropropylene as a binder, wherein the graphite has an I_{[110]c}/I_{[004]c} ratio of 0.13 or more (wherein I_{[110]c} is X-ray diffraction peak intensity on the [110]c plane and I_{[004]c} is that on the [004]c plane, determined by X-ray diffraction 2θ/θ analysis of graphite relative to the principal plane of negative electrode. At the ratio below 0.13, the lithium secondary battery will have a low initial capacity and insufficient cyclic characteristics, as with the conventional electrode. The ratio is preferably 0.15 or more.

The meaning of crystalline orientation of natural graphite particles in a negative electrode is described. It is believed that graphite stores the lithium ion by intercalation and releases the ion by deintercalation, with the a-plane serving as the door way. The graphite crystal, having a layered structure, has a crystal habit of taking a flaky shape. Natural graphite has high crystallinity, as discussed earlier, and will have noted tendency of becoming flaky particles.

The conventional negative electrode for lithium secondary battery contains the flaky particles formed into a plate or sheet shape, after being mixed with a binder, and the c-axis of the graphite crystal in a negative electrode tends to be oriented towards the principal surface of the electrode (so-called c-axis orientation), which is considered to interfere with insertion/elimination of the lithium ion and to cause initial capacity lower than the theoretical level. Moreover, the volumetric expansion and contraction resulting from the insertion and elimination of the lithium ion slant to the plate or sheet thickness direction, which tends to destroy the electrode (in particular separation from a current collector) even in the presence of copolymer of polyvinylidene fluoride and hexafluoropropylene as a binder, and cause insufficient cyclic characteristics. Still more, the graphite crystal has an electroconductivity notably lower in the c-axis direction than on the c-plane, and the c-axis orientation of the graphite crystal possibly causes a disadvantage of increased electric resistance (or increased Joule loss).

On the other hand, the negative electrode of the present invention for lithium secondary battery contains the graphite particles whose c-axis runs in parallel to the electrode thickness direction (i.e., it's a-axis is oriented to the principal electrode direction) at a significant content. This brings an effect of increasing the initial capacity, because the lithium ions are inserted or eliminated more easily than in the conventional electrode. Moreover, the volumetric expansion and contraction resulting from the insertion and elimination of the lithium ion are isotropic as a whole to suppress electrode destruction and thereby to improve the cyclic characteristics beyond those of the conventional electrode. Still more, the negative electrode will have increased number of electroconductive paths in the thickness direction to bring an effect of decreasing electric resistance (or Joule loss).

The natural graphite in the negative electrode of the present invention preferably has an aspect ratio La/Lc of from 0.9 to 1.1 (wherein La is an average size in the a-axis direction of the crystallite and Lc is an average size in the c-axis direction). This can more easily secure the graphite I_{[110]c}/I_{[004]c} ratio of 0.13 or more, determined by XRD analysis. The aspect ratio is more preferably from 1 to 1.1.

The binder for the present invention, which is kneaded with the natural graphite, preferably has a molecular weight of 800,000 to 1,200,000, inclusive. This facilitates viscosity adjustment for the slurry containing the negative electrode material while the electrode is prepared and suppresses settling of the natural graphite particles to more easily keep the I_{[110]c}/I_{[004]c} ratio at 0.13 or more. A copolymer of polyvinylidene fluoride and hexafluoropropylene is a preferable binder material, because of its effects of suppressing electrode destruction (in particular separation from a current collector).

Next, the method for evaluation of the I_{[110]c}/I_{[004]c} ratio, defined in this specification and determined by XRD analysis, is described. The plate- or sheet-shape negative electrode as the specimen is prepared, and fixed on a specimen holder (e.g., that of glass substrate) using a fixing agent (e.g., silicon grease or double-faced tape) while keeping the principal surface flat, and is set in a common wide-angle goniometer to determine the ratio of I_{[110]c} at 2θ of around 77 to 78° to I_{[004]c} at 2θ of around 54 to 55°.

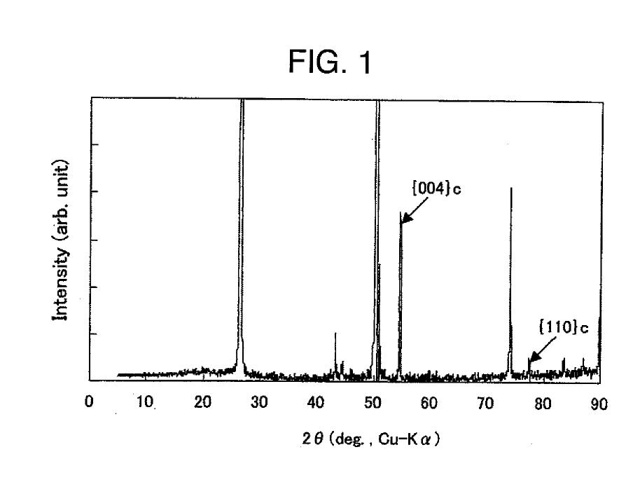

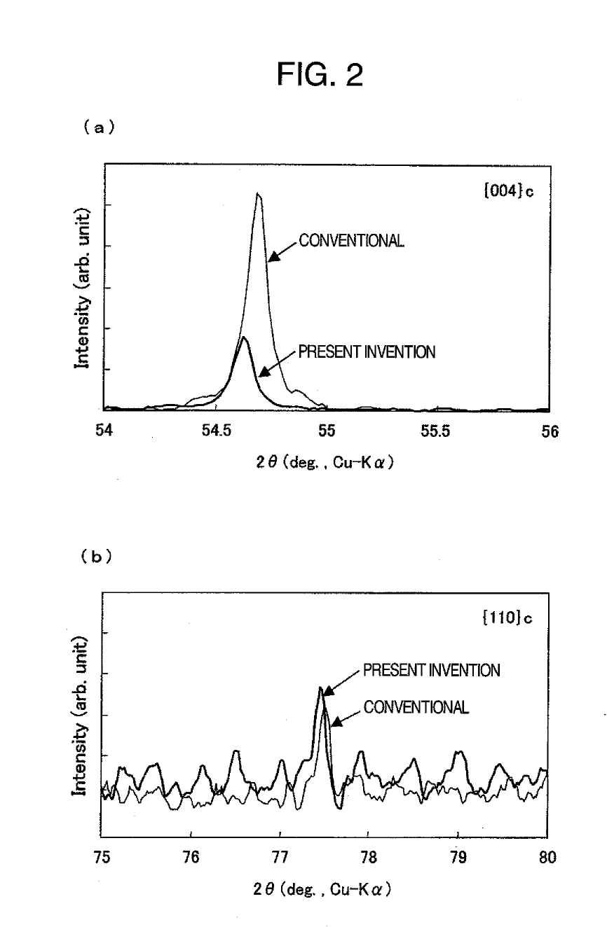

The XRD analysis results are given in FIGS. 1 and 2. FIG. 1 shows one example of the XRD analysis results (XRD chart) of the negative electrode of the present invention for lithium secondary battery. FIG. 2 shows partly magnified XRD charts of the negative electrode of the present invention and conventional negative electrode for lithium secondary battery, wherein (a) diffraction peaks of the [004]c plane and (b) diffraction peaks of the [110]c plane.

FIG. 1 clearly shows the XRD peaks of the graphite [004]c plane and [110]c plane. FIG. 2 shows that the peak of the [004]c plane of the present invention decreases to about one-third that of the peak of the conventional electrode, and that the peak of the [110]c plane of the present invention has an intensity at least comparable with that of the conventional electrode, by which is meat that the negative electrode of the present invention contains the graphite particles whose c-axis runs in parallel to the electrode thickness direction at a significant content.

The XRD analyzer used is RINT-Ultima III (supplied by Rigaku) with a copper target, operating at tube voltage and current of 48 kV and 40 mA. The slit conditions are 10 mm (longitudinal divergence slit), ½° (divergence slit), ½° (dispersion slit) and 0.5 mm (light-receiving slit).

### (Manufacture of the Negative Electrode for Lithium Secondary Battery)

The method for manufacture of the negative electrode of the present invention for lithium secondary battery is not limited as long as it gives the lithium secondary battery satisfying the requirements of the present invention. One example of the method is described below.

First, spherical natural graphite particles having an aspect ratio La/Lc of around 1 (La: average size in the a-axis direction of the crystallite, Lc: average size in the c-axis direction) are prepared as the electrode-active material. Then, the particles are incorporated with acetylene black as an electroconductive material at 1 to 5% by mass.

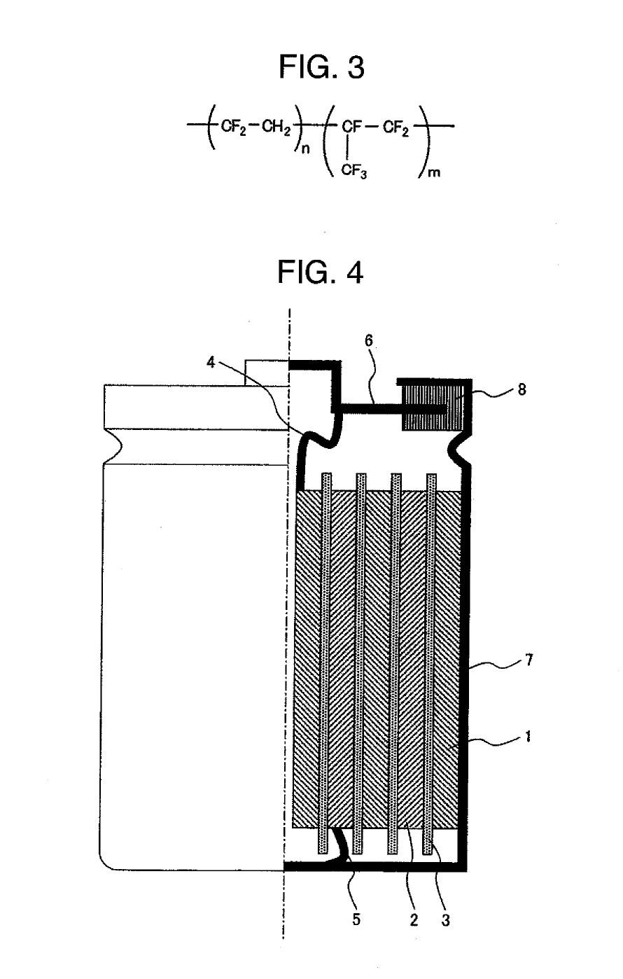

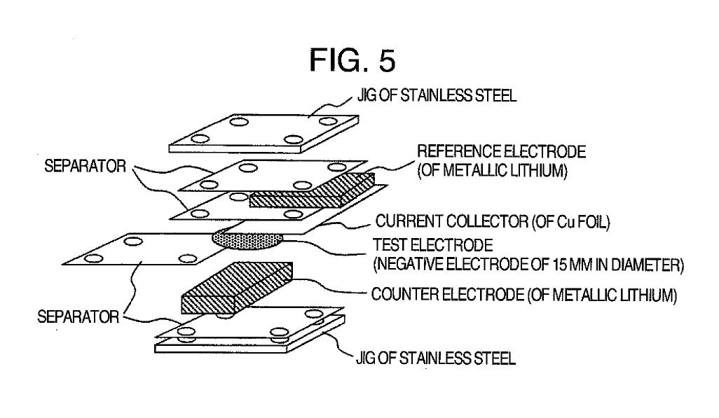

Then, N-methyl-2-pyrrolidone is incorporated with a copolymer of polyvinylidene fluoride and hexafluoropropylene (refer to FIG. 3) as a binder at 5% by mass to prepare the solution. The solution is added to the natural graphite to 4 to 8% by mass, and the resulting mixture is kneaded, to which N-methyl-2-pyrrolidone is further added to prepare the slurry containing the negative electrode material (hereinafter referred to as negative electrode mixture slurry). The slurry is preferably prepared to have solids (natural graphite, electroconductive material and binder) content of 45% by mass or more. FIG. 3 shows a general chemical composition formula of copolymer of polyvinylidene fluoride and hexafluoropropylene. In FIG. 3, an average ratio m:n can be about 1:1.

The copolymer of polyvinylidene fluoride and hexafluoropropylene (PVDF-HFP copolymer) preferably has a molecular weight of 800,000 to 1,200,000, inclusive. By setting the solids content in the negative electrode mixture slurry and binder molecular weight at the above levels, viscosity of the slurry can be adjusted in an adequate range, suppressing settling of the natural graphite particles to more easily keep the I_{[110]c}/I_{[004]c} ratio at 0.13 or more.

The negative electrode mixture slurry thus prepared is spread on each side of a current collector (e.g., of copper foil) and dried. The coated collector is compression-molded by a roll press or the like, and cut to prepare the negative electrode of given size for lithium secondary battery.

### (Lithium Secondary Battery)

The lithium secondary battery of the present invention is not limited as long as it includes the negative electrode of the present invention. One preferable example is described below.

One example of the method for manufacture of the positive electrode is described. The preferable electrode-active materials include the lithium compounds represented by LiCoO₂, LiNiO₂, LiMnₓNi₁₋ₓO₂ (0.001≦×≦0.5), LiMn₂O₄ and LiMnO₂. The electrode-active material is incorporated with synthetic graphite as an electroconductive agent and binder (e.g., of polyvinylidene fluoride or ethylene-propylene-diene copolymer dissolved in a solvent, e.g., 1-methyl-2-pyrrolidone), and the resulting mixture is kneaded to prepare the positive electrode mixture slurry.

The positive electrode mixture slurry thus prepared is spread on each side of a current collector (e.g., of copper foil) and dried. The coated collector is compression-molded by a roll press or the like, and cut to have a given size. A lead piece (e.g., of nickel foil) for outputting current is welded to the coated collector to prepare the positive electrode.

The method for manufacture of the negative electrode is described earlier. A lead piece (e.g., of nickel foil) for outputting current is welded to the electrode of given size to prepare the electrode for lithium secondary battery.

FIG. 4 shows one example of partial longitudinal sectional view of the lithium secondary battery (cylindrical battery). A group of electrodes is assembled by winding a positive electrode 1 and negative electrode 2 via a separator 3 of porous polymer film or the like to prevent the electrodes from directly coming into contact with each other. The group of electrodes is then set in a battery case 7 (e.g., of stainless steel, diameter: 18 mm and length: 65 mm), and a lead piece 5 for the negative electrode is welded to the case bottom and a lead piece 4 for the positive electrode is welded to a positive electrode lid 6, which also serves as a terminal for the positive electrode.

The case 7 is filled with a non-aqueous electrolytic solution and closed by swaging the positive electrode lid 6, to which the positive electrode terminal is attached, to prepare the cylindrical lithium secondary battery 10. The preferable non-aqueous electrolytic solutions include those of ethylene carbonate, methylethyl carbonate, propylene carbonate, dimethyl carbonate, 1,2-dimethoxyethane and tetrahydrofuran. They may be used either individually or in combination. The preferable electrolytes include lithium perchlorate, lithium borofluoride and lithium bistrifluoromethylsulfoneimide.

The present invention is described in more detail by Examples, which by no means limit the present invention.

### EXAMPLES

### Evaluation of Negative Electrode for Lithium Secondary Battery

A negative electrode for lithium secondary battery was prepared, where natural graphite as an electrode-active material was a mixture of spherical particles and flaky particles having an aspect ratio La/Lc of 0.9 to 1.1 (wherein La is an average size in the a-axis direction of the graphite crystallite and Lc is an average size in the c-axis direction) and 0.85, respectively. Each of the particle types was incorporated with an acetylene black as an electroconductive agent at 1.6% by mass.

A copolymer of polyvinylidene fluoride and hexafluoropropylene and polyvinylidene fluoride were prepared as the binders, each having a molecular weight of 400,000 to 1,400,000. N-methyl-2-pyrrolidone was incorporated with the binder at 5% by mass to prepare the solution, which was added to the natural graphite to 6.2% by mass. The resulting mixture was kneaded, to which N-methyl-2-pyrrolidone was further added to varying contents to prepare negative electrode mixture slurries. The slurry was adjusted to have a solids content of 30 to 50% by mass.

Each of the negative electrode mixture slurries thus prepared was spread on each side of copper foil as a current collector and dried. The coated collector was compression-molded by a roll press or the like, and cut to prepare the negative electrode of given size for lithium secondary battery. The electrode thickness (total coating layer thickness) was 113 μm.

Each of the negative electrodes for lithium secondary battery prepared in Examples 1-1 to 1-4 and Comparative Examples 1-1 to 1-8 were analyzed by XRD to determine the I_{[110]c}/I_{[004]c} ratios. The results are given in Table 1.

TABLE 1

| | | | Binder | | |
|---|---|---|---|---|---|
| Negative | | | molecular | Solids | |
| electrode | La/Lc | Binder | weight | content | I_{[110]c}/I_{[004]c} |
| Example 1-1 | 1.1 | Copolymer of | 1,000,000 | 50% by | 0.16 |
| | | polyvinylidene | | mass | |
| Example 1-2 | 1.1 | fluoride and | 1,000,000 | 45% by | 0.14 |
| | | hexafluoro- | | mass | |
| Example 1-3 | 0.9 | propylene | 1,200,000 | 45% by | 0.16 |
| | | | | mass | |
| Example 1-4 | 1.1 | | 800,000 | 50% by | 0.13 |
| | | | | mass | |
| Comparative | 1.1 | | 1,000,000 | 40% by | 0.11 |
| Example 1-1 | | | | mass | |
| Comparative | 1.1 | | 1,000,000 | 35% by | 0.08 |
| Example 1-2 | | | | mass | |
| Comparative | 1.1 | | 1,000,000 | 30% by | 0.04 |
| Example 1-3 | | | | mass | |
| Comparative | 1.1 | | 400,000 | 50% by | 0.06 |
| Example 1-4 | | | | mass | |
| Comparative | 1.1 | | 600,000 | 50% by | 0.11 |
| Example 1-5 | | | | mass | |
| Comparative | 1.1 | | 1,400,000 | 30% by | Unable to |
| Example 1-6 | | | | mass | spread the |
| | | | | | slurry |
| Comparative | 1.1 | Polyvinylidene | 400,000 | 50% by | 0.04 |
| Example 1-7 | | fluoride | | mass | |
| Comparative | 0.85 | Copolymer of | 1,000,000 | 50% by | 0.04 |
| Example 1-8 | | polyvinylidene | | mass | |
| | | fluoride and | | | |
| | | hexafluoro- | | | |
| | | propylene | | | |

As shown in Table 1, each of the negative electrodes of the present invention for lithium secondary battery had an I_{[110]c}/I_{[004]}ratio of 0.13 or more. By contrast, each of the negative electrodes, which did not satisfy any one of the conditions of “graphite crystallite aspect ratio: from 0.9 to 1.1”, “binder: copolymer of polyvinylidene fluoride and hexafluoropropylene”, “binder molecular weight: 800,000 to 1,200,000” and “solids content in the negative electrode mixture slurry: 45% by mass or more”, had an I_{[110]c}/I_{[004]c} ratio below 0.13 or was unable to spread.

### Evaluation by Test Cell

The negative electrodes for lithium secondary battery prepared in Examples 1-1 to 1-4 and Comparative Examples 1-1 to 1-8 were used to prepare test cells (Examples 2-1 to 2-4 and Comparative Examples 2-1 to 2-8). The test cell comprised counter and reference electrodes of metallic lithium, a separator of 40 μm thick porous polyethylene film, electrolytic solution of a mixture of ethylene carbonate and methylethyl carbonate (mixing ratio of 1:2 by volume) incorporated with LiPF₆ at 1 M, and current collector of copper foil.

Each of the test cells prepared in Examples 2-1 to 2-4 and Comparative Examples 2-1 to 2-8 was evaluated for its initial discharge capacity characteristics and cyclic characteristics by the following procedure under constant-current/constant-voltage charging conditions of voltage: 5 mV, current: 4 mA(initial) and 30 μA (final) and downtime: 1 hour, and discharging conditions of current: 4 mA and cut voltage: 1.5 V.

For the initial discharge capacity characteristics, the initial discharge capacity per unit weight of natural graphite as the electrode-active material was measured after the first charge/discharge cycle under the above conditions was over, and the theoretical capacity ratio, i.e., ratio of the initial capacity to the theoretical capacity of graphite (372 mAh/g) was determined. For the cyclic characteristics, the discharge capacity was measured after the 200^{th} charge/discharge cycle under the above conditions was over, and was compared with the initial capacity to determine the discharge capacity maintenance factor (ratio of the discharge capacity measured after the 200^{th} cycle was over to the initial discharge capacity). The results are given in Table 2.

TABLE 2

| | | | Initial discharge capacity characteristics | | Cyclic characteristics | |
|---|---|---|---|---|---|---|
| | | | Initial discharge | Theoretical | Discharge | Discharge capacity |
| | Negative | | capacity | capacity ratio | capacity | maintenance factor |
| Test cell | electrode | I_{[110]c}/I_{[004]c} | (mAh/g) | (%) | (mAh/g) | (%) |
| Example 2-1 | Example 1-1 | 0.16 | 360 | 97 | 338 | 94 |
| Example 2-2 | Example 1-2 | 0.14 | 360 | 97 | 335 | 93 |
| Example 2-3 | Example 1-3 | 0.16 | 360 | 97 | 338 | 94 |
| Example 2-4 | Example 1-4 | 0.13 | 358 | 96 | 330 | 92 |
| Comparative | Comparative | 0.11 | 348 | 94 | 320 | 82 |
| Example 2-1 | Example 1-1 | | | | | |
| Comparative | Comparative | 0.08 | 344 | 92 | 241 | 70 |
| Example 2-2 | Example 1-2 | | | | | |
| Comparative | Comparative | 0.04 | 325 | 87 | 163 | 50 |
| Example 2-3 | Example 1-3 | | | | | |
| Comparative | Comparative | 0.06 | 330 | 89 | 165 | 50 |
| Example 2-4 | Example 1-4 | | | | | |
| Comparative | Comparative | 0.11 | 347 | 93 | 281 | 81 |
| Example 2-5 | Example 1-5 | | | | | |
| Comparative | Comparative | Unable to | — | — | — | — |
| Example 2-6 | Example 1-6 | spread the | | | | |
| | | slurry | | | | |
| Comparative | Comparative | 0.04 | 323 | 87 | 158 | 49 |
| Example 2-7 | Example 1-7 | | | | | |
| Comparative | Comparative | 0.04 | 327 | 88 | 164 | 50 |
| Example 2-8 | Example 1-8 | | | | | |

The present invention is aimed to simultaneously satisfy a high energy density and good charge/discharge cyclic characteristics of a negative electrode for lithium secondary battery, where high energy density means an initial discharge capacity of at least 95% of the theoretical capacity and good charge/discharge cyclic characteristics means a discharge capacity maintenance factor of at least 90% of the initial discharge capacity, each of which is difficult to achieve by the conventional techniques. As shown in Table 2, each of the test cells of the present invention having a negative electrode

I_{[110]c}/I_{[004]c} ratio of 0.13 or more, prepared in Examples 2-1 to 2-4, simultaneously satisfies an initial discharge capacity of at least 95% of the theoretical capacity and discharge capacity maintenance factor of at least 90% of the initial discharge capacity. By contrast, each of the test cells having a negative electrode I_{[110]c}/I_{[004]c} ratio below 0.13, prepared in Comparative Examples 2-1 to 2-8, fails to satisfy each of the initial discharge capacity characteristics and cyclic characteristics targeted by the present invention. In Comparative Example 2-6, the negative electrode itself could not be prepared, because the negative electrode mixture slurry could not be spread, and the measurement was not carried out.

### Evaluation of Lithium Secondary Battery

The negative electrodes for lithium secondary battery prepared in Examples 1-1 to 1-4 and Comparative Examples 1-1 to 1-8 were used to prepare lithium secondary batteries, illustrated in FIG. 4 (Examples 3-1 to 3-4 and Comparative Examples 3-1 to 3-8). A lead piece of nickel foil was welded to the negative electrode for outputting current.

The lithium secondary battery was prepared by the following procedure. LiMn₂O₄ as an electrode-active material was incorporated with synthetic graphite as an electroconductive agent and binder (polyvinylidene fluoride dissolved in N-methyl-2-pyrrolidone), and the resulting mixture was kneaded to prepare the positive electrode mixture slurry. The slurry was adjusted to contain the electrode-active material, electroconductive agent and binder at 87, 8.7 and 4.3% by mass, respectively. The positive electrode mixture slurry thus prepared was spread on each side of a current collector of aluminum foil and dried at 100° C. The coated collector was compression-molded by a roll press, and cut to have a given size. A lead piece of aluminum foil for outputting current was welded to the coated collector to prepare the positive electrode.

A group of electrodes was assembled by winding the positive electrode and negative electrode via a separator of microporous polypropylene film (thickness: 40 and porosity: 40%) to prevent the electrodes from directly coming into contact with each other. The group of electrodes was then set in a battery case of stainless steel (diameter: 18 mm and length: 65 mm), and a lead piece for the negative electrode was welded to the case bottom and a lead piece for the positive electrode was welded to a positive electrode lid, which also served as a terminal for the positive electrode. The case was filled with 5 g of a non-aqueous electrolytic solution and closed by swaging the positive electrode lid, to which the positive electrode terminal was attached, via a gasket 8 to prepare the cylindrical lithium secondary battery. The non-aqueous electrolytic solution was of a mixed solvent of ethylene carbonate and methylethyl carbonate (mixing ratio: ½) incorporated with vinylene carbonate at 1% by mass with LiPF₆ as the electrolyte at 1 M.

Each of the test cells prepared in Examples 3-1 to 3-4 and Comparative Examples 3-1 to 3-8 was evaluated for its battery capacity characteristics and cyclic characteristics by the following procedure under constant-current/constant-voltage charging conditions of current: 600 mA, upper-limit voltage: 4.2 V and charging time: 4 hours, and constant-current discharging conditions of current: 600 mA and lower-limit voltage: 2.7 V. The battery capacity characteristics was represented by the discharge capacity measured after the first cycle was over, and the cyclic characteristics was represented by the discharge capacity maintenance factor, which is the ratio of the discharge capacity measured after the 100^{th} cycle was over to that observed after the first cycle was over. The results are given in Table 3.

TABLE 3

| | | | | Discharge |
|---|---|---|---|---|
| Lithium | | | Battery | capacity |
| secondary | Negative | | capacity | maintenance |
| battery | electrode | I_{[110]c}/I_{[004]c} | (mAh/g) | factor (%) |
| Example 3-1 | Example 1-1 | 0.16 | 830 | 91 |
| Example 3-2 | Example 1-2 | 0.14 | 824 | 91 |
| Example 3-3 | Example 1-3 | 0.16 | 830 | 91 |
| Example 3-4 | Example 1-4 | 0.13 | 820 | 90 |
| Comparative | Comparative | 0.11 | 750 | 76 |
| Example 3-1 | Example 1-1 | | | |
| Comparative | Comparative | 0.08 | 730 | 68 |
| Example 3-2 | Example 1-2 | | | |
| Comparative | Comparative | 0.04 | 680 | 43 |
| Example 3-3 | Example 1-3 | | | |
| Comparative | Comparative | 0.06 | 700 | 43 |
| Example 3-4 | Example 1-4 | | | |
| Comparative | Comparative | 0.11 | 748 | 75 |
| Example 3-5 | Example 1-5 | | | |
| Comparative | Comparative | Unable to | — | — |
| Example 3-6 | Example 1-6 | spread the | | |
| | | slurry | | |
| Comparative | Comparative | 0.04 | 676 | 28 |
| Example 3-7 | Example 1-7 | | | |
| Comparative | Comparative | 0.04 | 677 | 42 |
| Example 3-8 | Example 1-8 | | | |

As shown in Table 3, each of the lithium secondary batteries of the present invention having a negative electrode I_{[110]c}/I_{[004]c} ratio of 0.13 or more, prepared in Examples 3-1 to 3-4, simultaneously satisfies a high battery capacity and discharge capacity maintenance factor of at least 90%. By contrast, each of the test cells having a negative electrode I_{[110]c}/I_{[004]c} ratio below 0.13, prepared in Comparative Examples 3-1 to 3-8, has a discharge capacity maintenance factor below 90% and insufficient battery capacity. In Comparative Example 3-6, the negative electrode itself could not be prepared, because the negative electrode mixture slurry could not be spread, and the measurement was not carried out.

As discussed above, it has been demonstrated that the negative electrode of the present invention can give a lithium secondary battery which simultaneously satisfies high energy density and good charge/discharge cyclic characteristics. The negative electrode for lithium secondary battery and lithium battery with the negative electrode, both of the present invention, can improve performance of portable electronic devices, power storage sources, electric vehicles and so on.

It should be further understood by those skilled in the art that although the foregoing description has been made on embodiments of the invention, the invention is not limited thereto and various changes and modifications may be made without departing from the spirit of the invention and the scope of the appended claims.

### DESCRIPTION OF REFERENCE NUMERALS

1: Positive electrode for lithium secondary battery, 2: Negative electrode for lithium secondary battery, 3: Separator, 4: Lead piece for the positive electrode, 5: Lead piece for the negative electrode, 6: Positive electrode lid, 7: battery case, 8: Gasket, 10: Cylindrical lithium secondary battery

1. A negative electrode for lithium secondary battery,
wherein the negative electrode contains natural graphite as an active material and contains a copolymer of polyvinylidene fluoride and hexafluoropropylene as a binder, and
the graphite has an I_{[110]c}/I_{[004]c} ratio of 0.13 or more (wherein is X-ray diffraction peak intensity of [110]c plane and I_{[004]c} is x-ray diffraction peak intensity of [004]c plane, determined by X-ray diffraction 2θ/θ analysis of graphite relative to a principal plane of the electrode).

2. The negative electrode for lithium secondary battery according to claim 1, wherein the natural graphite has an aspect ratio La/Lc of from 0.9 to 1.1 (wherein La is an average size in a-axis direction and Lc is an average size in c-axis direction in a graphite crystallite).

3. The negative electrode for lithium secondary battery according to claim 1, wherein the binder has a molecular weight of from 800,000 to 1,200,000.

4. A lithium secondary battery having a positive electrode and negative electrode facing each other via a separator and containing an electrolytic solution,
wherein the positive electrode contains a positive electrode-active material and the negative electrode contains a negative electrode-active material, wherein the negative electrode is the electrode according to claim 1.

5. A lithium secondary battery having a positive electrode and negative electrode facing each other via a solid electrolyte and containing an electrolytic solution,
wherein the positive electrode contains a positive electrode-active material and the negative electrode contains a negative electrode-active material, wherein the negative electrode is the electrode according to claim 1.

6. The lithium secondary battery according to claim 2, wherein the binder has a molecular weight of from 800,000 to 1,200,000.

7. A lithium secondary battery having a positive electrode and negative electrode facing each other via a separator and containing an electrolytic solution,
wherein the positive electrode contains a positive electrode-active material and the negative electrode contains a negative electrode-active material, wherein the negative electrode is the electrode according to claim 2.

8. A lithium secondary battery having a positive electrode and negative electrode facing each other via a solid electrolyte and containing an electrolytic solution,
wherein the positive electrode contains a positive electrode-active material and the negative electrode contains a negative electrode-active material, wherein the negative electrode is the electrode according to claim 2.

9. A lithium secondary battery having a positive electrode and negative electrode facing each other via a separator and containing an electrolytic solution,
wherein the positive electrode contains a positive electrode-active material and the negative electrode contains a negative electrode-active material, wherein the negative electrode is the electrode according to claim 3.

10. A lithium secondary battery having a positive electrode and negative electrode facing each other via a solid electrolyte and containing an electrolytic solution,
wherein the positive electrode contains a positive electrode-active material and the negative electrode contains a negative electrode-active material, wherein the negative electrode is the electrode according to claim 3.
